(19) United States
(12) Patent Application Publication
(10) Pub. No.: US 2023/0284124 A1
(43) Pub. Date: Sep. 7, 2023

(54) 2G SON (Self-Organizing-Networks) ANR (Automatic-Neighbor-Relation)

(71) Applicant: Parallel Wireless, Inc., Nashua, NH (US)

(72) Inventors: David Khemelevsky, Kfar Sava (IL); Vikram Karandikar, Nashua, NH (US)

(21) Appl. No.: 18/179,360

(22) Filed: Mar. 6, 2023

Related U.S. Application Data
(60) Provisional application No. 63/316,637, filed on Mar. 4, 2022.

(51) Int. Cl. H04W 48/16; H04W 48/20

(52) U.S. Cl. CPC H04W 48/16; H04W 48/20

(57) ABSTRACT

A method is disclosed comprising: obtaining 4G user equipment (UE) statistics at a base station; using the 4G UE statistics to perform ranking of 2G base station neighbors; replacing a low-ranked 2G base station neighbor in a neighbor list with a 2G base station neighbor that is higher ranked than the low-ranked 2G base station neighbor; periodically repeating the ranking and replacing steps. The steps may be performed at a central location across multiple RATs. The ranking parameters may include geographically identified NBR records and whitelists/blacklists (WL/BL). The steps may be performed at at non-real time (non-RT) radio intelligent controller (RIC). Replacing may be performed using a minimum impact threshold.

### CROSS-REFERENCE TO RELATED APPLICATIONS

The present application claims priority under 35 U.S.C. § 119(e) to U.S. Provisional Patent Application No. 63/316,637, having the same title as the present application and filed Mar. 4, 2022, hereby incorporated by reference in its entirety for all purposes.

In addition, this application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; US20170257133A1; and US20200128414A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1, US20200128414A1, US20230019380A1 in their entirety.

### BACKGROUND

One part of SON (self-organizing network) features is ANR (Automatic neighbor relations). Introduced for 4G/5G (partially in 3G), ANR provides the MNO (mobile network operators) with dynamic neighbor management to reduce Opex related to constant and never-ending optimization problems of mobility. The denser the area, the more likely it is that more neighbors are required. Adding to this challenge is a multitude of confusing use cases such as swap (changing vendor equipment), rehoming (changing location), reparenting (changing the BSC), deployment (new cell introduction), configuration changes (e-tilt, power). All of these use cases benefit from continuous optimization and evaluation of neighbor management. It is also important to mention that no algorithm is perfect or can cover all conceivable use cases. There will be always some scenarios for which human supervision may be required.

### SUMMARY

A method is disclosed comprising: obtaining 4G user equipment (UE) statistics at a base station; using the 4G UE statistics to perform ranking of 2G base station neighbors; replacing a low-ranked 2G base station neighbor in a neighbor list with a 2G base station neighbor that is higher ranked than the low-ranked 2G base station neighbor; periodically repeating the ranking and replacing steps. The steps may be performed at a central location across multiple RATs. The ranking parameters may include geographically identified NBR records and whitelists/blacklists (WL/BL). The steps may be performed at at non-real time (non-RT) radio intelligent controller (RIC). Replacing may be performed using a minimum impact threshold.

### BRIEF DESCRIPTION OF THE DRAWINGS

FIG. 1 is a schematic illustration of the development of NRT tables over a period of time, in accordance with some embodiments.

FIG. 2 is a schematic illustration of how existing various neighbors are ranked, in accordance with some embodiments.

FIG. 3 is a schematic illustration of post ranking and the replacement process for new revealed candidates, in accordance with some embodiments.

FIG. 4 shows a schematic architecture for the 2G SON ANR solution, in accordance with some embodiments.

FIG. 5 shows a call flow using the cSON approach utilizing various inputs and RAT stats for NRT optimization, in accordance with some embodiments.

FIG. 6 is a schematic network architecture diagram for 3G and other-G prior art networks.

FIG. 7 is a schematic diagram of a multi-RAT RAN deployment architecture, in accordance with some embodiments.

FIG. 8 is a coordinating server for providing services and performing methods as described herein, in accordance with some embodiments.

### DETAILED DESCRIPTION

This system simplifies and reduces the complexity of 2G SON ANR algorithms, which are commonly either non-standard implementations or per-vendor implementation, keeping in mind those objectives as defined in the 4G/5G RAT.

This system is able to supervise, monitor, detect and optimize the 2G neighbors, both 2G→2G, 2G→3G, 2G→4G using performance metrics. Also, and importantly, it can detect new candidates and evaluate those significance as compared to those already defined.

One aspect of the disclosed 2G SON ANR is, mainly from system perspective, how to detect new candidates and rank those as compared to existing relations on the cell. Thus this providing a holistic approach for prioritization and ability for human (manual) interventions to assist the ANR in special cases such as repeaters, femto, metro, etc.

Since 2G access is left outside from SON definition of 3GPP, there are no additional measurements or events that could help directly to manage the NRT (neighbor relation table) on the cell directly (in our case vNode). Hence we introduce the approach of cSON (centralized SON) to support the ability of managing an optimized NRT. One of the most critical points on cSON side is how to detect there is new potential candidates and rank this vs. current existing NRT. In some embodiments cSON may include performing operations using data from multiple cells or clusters of cells.

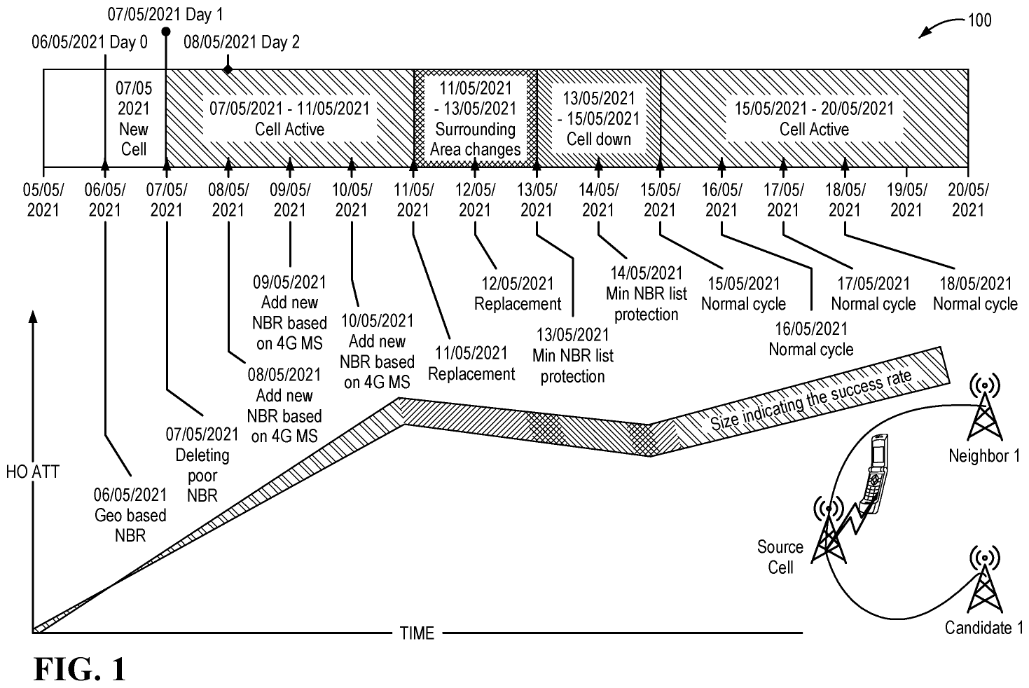

FIG. 1 is a schematic illustration of the development of NRT tables over a period of time, in accordance with some embodiments. At Day 0, a predetermined NRT is put together by the operator based on known geographic information. Subsequently, poor NBRs are deleted and new NBRs are added. In the present disclosure this is based on input from 4G mobile stations. The newly added NBRs replace previously stored records, while in the meantime the surrounding area changes. When a cell goes down, the NBR list is protected; however, when the cell comes back up the NBR list that is previously stored is able to be used again.

When a new candidate cell appears, in this case, the challenge SON algorithm facing is how to detect the candidate 1, compare it to existing list of NRT (neighbor 1), perform some ranking, and decide if replacement required.

The approach in this disclosure is to reveal new neighbors based on various conditions such as geo impact (assuming physical location known for source and target) and other RAT measurements (using the 4G-4G statistics, as known in the art and as differ for different RATs; the 2G statistics that correspond to the 4G statistics are also contemplated). This approach assuming that in most of the 2G deployments 4G site deployed and/or location known. Once candidates are known the existing neighbors and candidates are normalized to the similar scale of importance. Where each candidate and existing NRT have a ranking from 0-100 with accumulated sum of 100. From this point the optimization will perform gradual replacement from last ranked existing NBR compared to new candidates in cycling approach and re-evaluate periodically on changes.

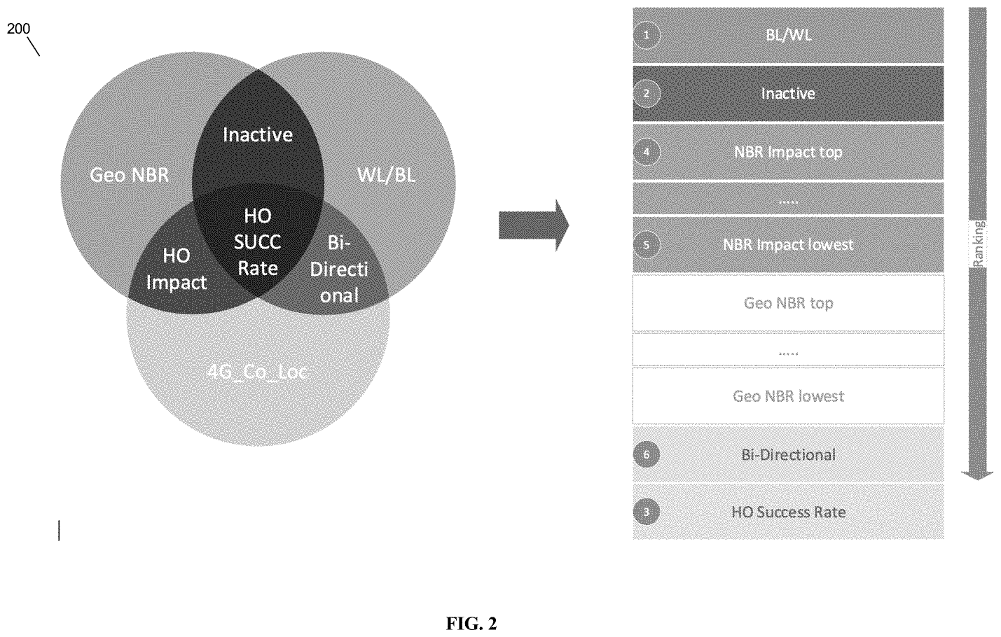

FIG. 2 is a schematic illustration of how existing various neighbors are ranked, in accordance with some embodiments. Three sources of data are used, in some embodiments; geographically identified NBR records; whitelists/blacklists (WL/BL); and 4G (or other RAT) UE data (4G_Co_Loc). Four additional computed sources of data are used: whether a previously identified base station is inactive; the handover success rate; the handover impact/impact on the NBR; whether the NBR is observable bidirectionally. In some embodiments, the ranking that is shown is used to weight the items. This may be performed at the cSON server, in some embodiments. 2G and 4G stats may be used, in some embodiments. In some embodiments only 4G stats may be used.

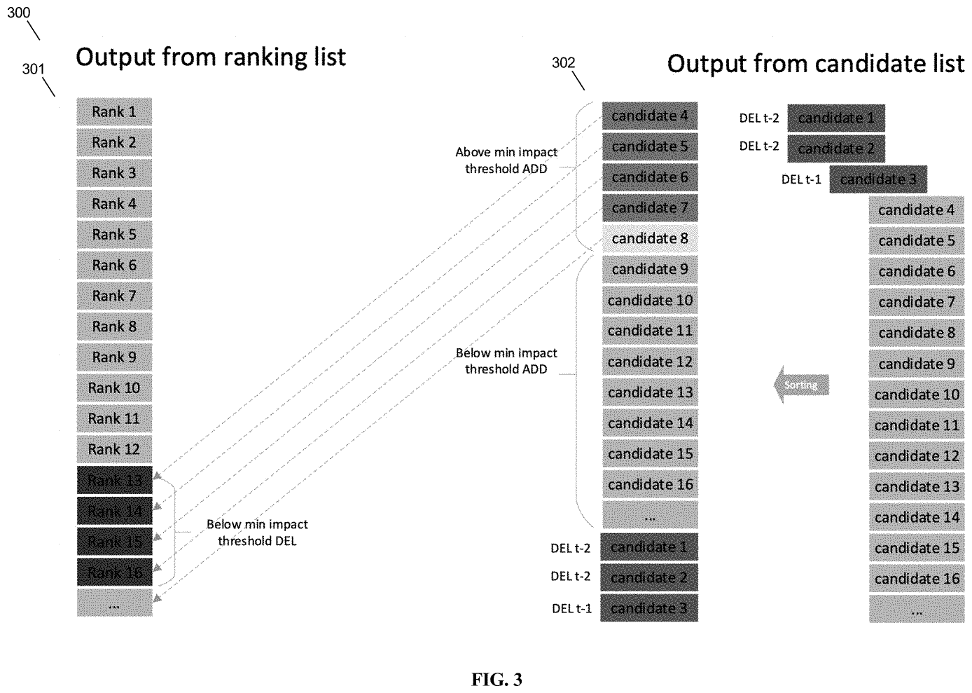

FIG. 3 is a schematic illustration of post ranking and the replacement process for new revealed candidates, in accordance with some embodiments. On the left side of FIG. 3 301, the output from a ranking list is shown, as maintained at the cSON server, with a few items being below a minimum impact threshold; those candidates are tagged for deletion. On the right side of FIG. 301 302, the output from a candidate list is shown, where an initial candidate list is sorted using the ranking parameters identified in FIG. 2. A minimum impact threshold is used to determine whether items should be added to the ranking list, in some embodiments. The add items are added and the delete items are deleted, in some embodiments. In some embodiments, items below the impact threshold may also be added.

Architecture Diagram

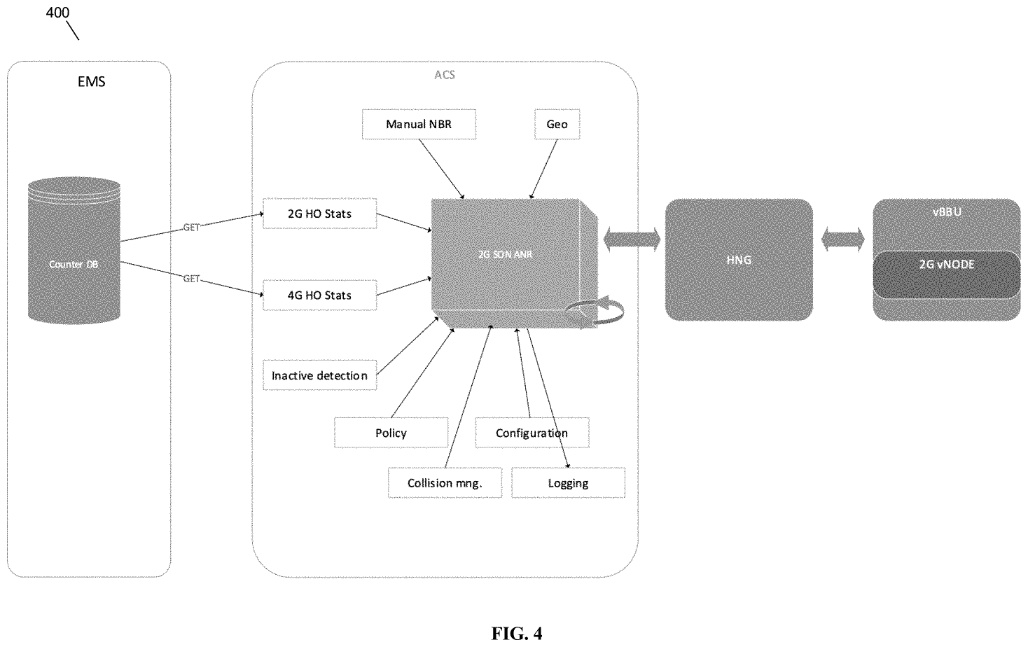

FIG. 4 shows a schematic architecture for the 2G SON ANR solution, in accordance with some embodiments. A counter database (EMS) may be in cooperation with a 2G SON ANR, which may be at a central location for providing cSON support or which may be at the data center in some embodiments. In some embodiments an HNG or a near-RT RIC or a non-RT RIC may be in communication with the SON ANR, which may then be in communication with the RAN, which may be a virtual baseband unit or vBBU that includes a virtual 2G vNODE. In some embodiments, cSON (centralized self-organizing networks) may involve the use of a coordinating server, which may be a HetNet Gateway, a near-real time RIC, or a non-real time RIC.

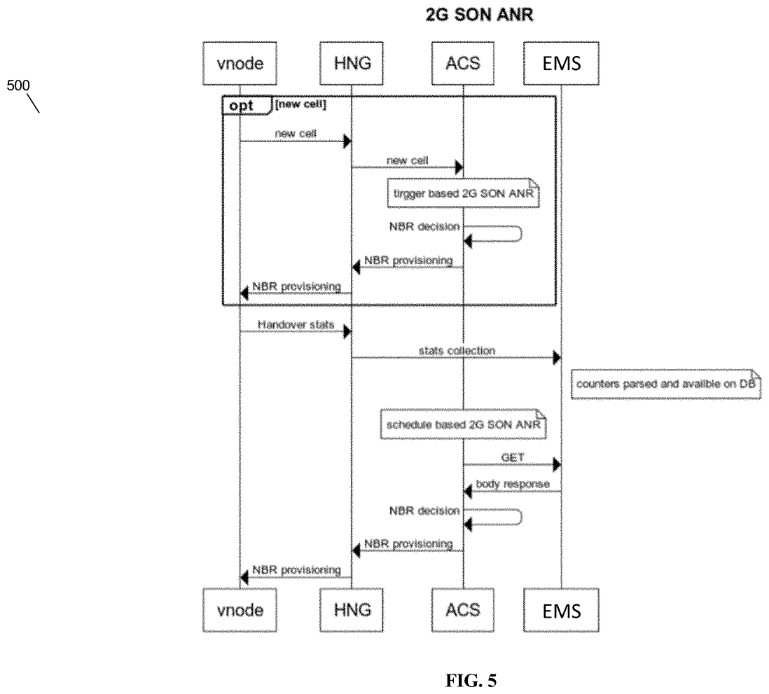

FIG. 5 shows a call flow using the cSON approach utilizing various inputs and RAT stats for NRT optimization, in accordance with some embodiments. When a new cell appears, the vNode (the 2G RAN) may inform the ACS server, which may provide NBR SON operation as described herein, which may perform NBR decisioning and provisioning. Stats collection, counter incrementation, and scheduling may be performed as an offline or near-line process and may feed this information back to the present process.

This approach may be operable for different RATs, and may also be able to handle both new cell or already in operation. In this case, the application keeps the same with same process of decision. The triggers for when it operates could be different. For example event for new cell, change on cell or surrounding cells configuration as BCCH and/or NRT, or simply periodical triggered event.

The application (2G SON ANR) will adopt based on the inputs it has. If new cell the Geo may be the leading factor.

Candidates evaluation. In this approach of a cached algorithm (also mentioned) the 2G Cell does not support sending UE measurement report. In such case, the replacement in order to work. Requires candidate detection that is not driven by the 2G HO stats (those are only for already defined NBR). So in order that the algorithm converging into steady state of best list. New candidates need to be detected and evaluated. In our case here, approach is using 4G measurements as additional input.

Ranking procedure and replacement process may be performed with prioritization across all the incoming variables, in some embodiments, including across multiple RATs.

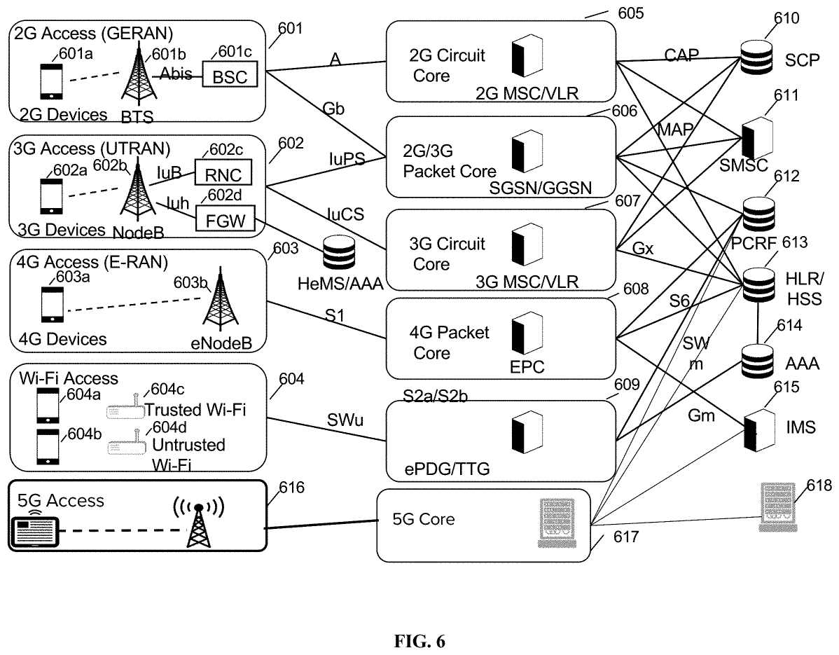

FIG. 6 is a schematic network architecture diagram for 3G and other-G prior art networks. The diagram shows a plurality of “Gs,” including 2G, 3G, 4G, 5G and Wi-Fi. 2G is represented by GERAN 601, which includes a 2G device 601a, BTS 601b, and BSC 601c. 3G is represented by UTRAN 602, which includes a 3G UE 602a, nodeB 602b, RNC 602c, and femto gateway (FGW, which in 3GPP namespace is also known as a Home nodeB Gateway or HNBGW) 602d. 4G is represented by EUTRAN or E-RAN 603, which includes an LTE UE 603a and LTE eNodeB 603b. Wi-Fi is represented by Wi-Fi access network 604, which includes a trusted Wi-Fi access point 604c and an untrusted Wi-Fi access point 604d. The Wi-Fi devices 604a and 604b may access either AP 604c or 604d. In the current network architecture, each “G” has a core network. 2G circuit core network 605 includes a 2G MSC/VLR; 2G/3G packet core network 606 includes an SGSN/GGSN (for EDGE or UMTS packet traffic); 3G circuit core 607 includes a 3G MSC/VLR; 4G circuit core 608 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 630, the SMSC 631, PCRF 632, HLR/HSS 633, Authentication, Authorization, and Accounting server (AAA) 634, and IP Multimedia Subsystem (IMS) 635. An HeMS/AAA 636 is present in some cases for use by the 3G UTRAN. The diagram is used to indicate schematically the basic functions of each network as known to one of skill in the art, and is not intended to be exhaustive. For example, 5G core 617 is shown using a single interface to 5G access 616, although in some cases 5G access can be supported using dual connectivity or via a non-standalone deployment architecture.

Noteworthy is that the RANs 601, 602, 603, 604 and 636 rely on specialized core networks 605, 606, 607, 608, 609, 637 but share essential management databases 630, 631, 632, 633, 634, 635, 638. More specifically, for the 2G GERAN, a BSC 601c is required for Abis compatibility with BTS 601b, while for the 3G UTRAN, an RNC 602c is required for Iub compatibility and an FGW 602d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

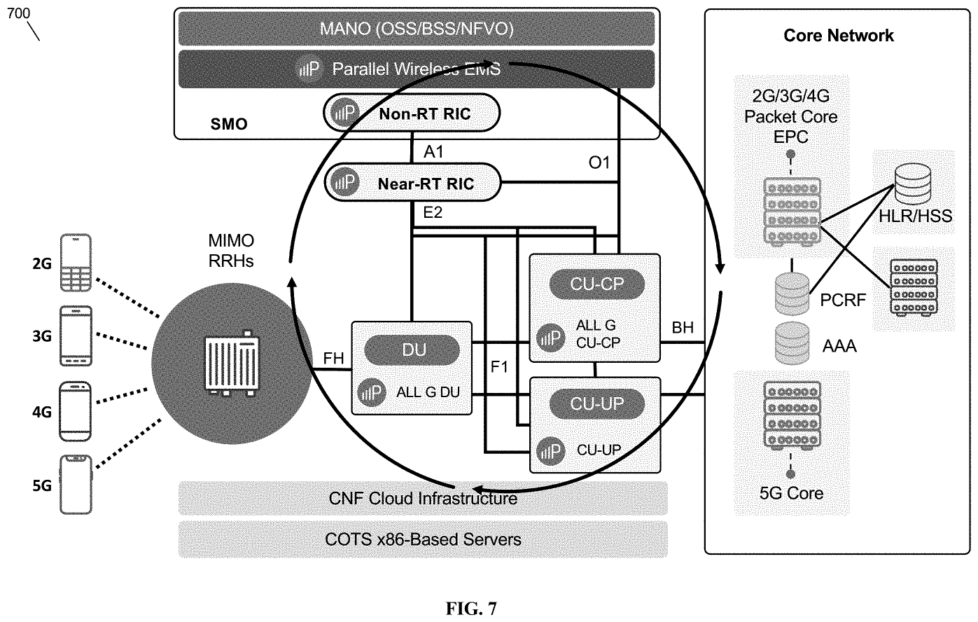

FIG. 7 is a schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

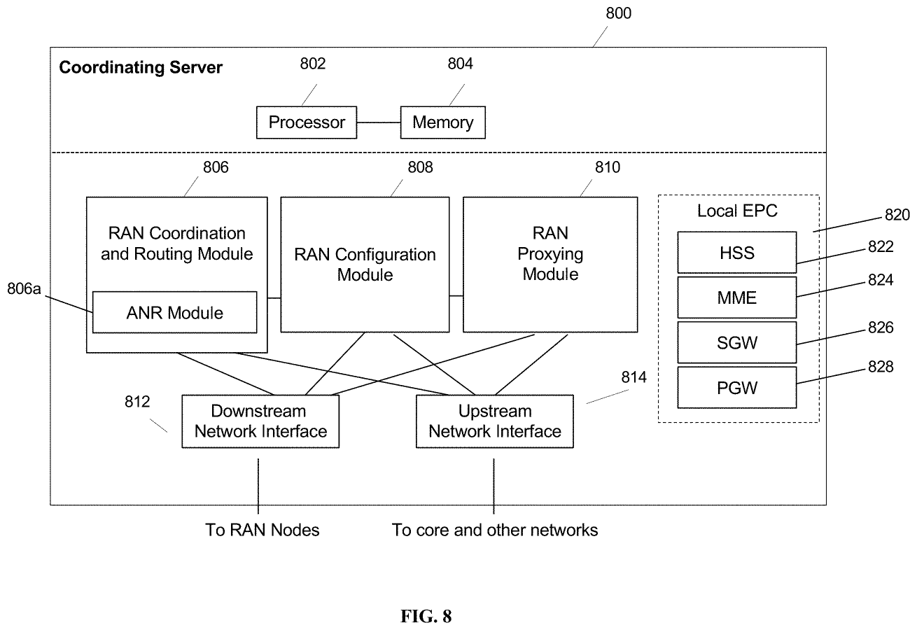

FIG. 8 is a coordinating server for providing services and performing methods as described herein, in accordance with some embodiments. Coordinating server 800 includes processor 802 and memory 804, which are configured to provide the functions described herein. Also present are radio access network coordination/routing (RAN Coordination and routing) module 806, including ANR module 806a, RAN configuration module 808, and RAN proxying module 810. The ANR module 806a may perform the ANR tracking, PCI disambiguation, ECGI requesting, and GPS coalescing and tracking as described herein, in coordination with RAN coordination module 806 (e.g., for requesting ECGIs, etc.). In some embodiments, coordinating server 800 may coordinate multiple RANs using coordination module 806. In some embodiments, coordination server may also provide proxying, routing virtualization and RAN virtualization, via modules 810 and 808. In some embodiments, a downstream network interface 812 is provided for interfacing with the RANs, which may be a radio interface (e.g., LTE), and an upstream network interface 814 is provided for interfacing with the core network, which may be either a radio interface (e.g., LTE) or a wired interface (e.g., Ethernet). In some embodiments the coordinating server may be a Parallel Wireless HetNet Gateway.

Coordinator 800 includes local evolved packet core (EPC) module 820, for authenticating users, storing and caching priority profile information, and performing other EPC-dependent functions when no backhaul link is available. Local EPC 820 may include local HSS 822, local MME 824, local SGW 826, and local PGW 828, as well as other modules. Local EPC 820 may incorporate these modules as software modules, processes, or containers. Local EPC 820 may alternatively incorporate these modules as a small number of monolithic software processes. Modules 806, 808, 810 and local EPC 820 may each run on processor 802 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than SlAP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method comprising:
obtaining 4G user equipment (UE) statistics at a base station;
using the 4G UE statistics to perform ranking of 2G base station neighbors;
replacing a low-ranked 2G base station neighbor in a neighbor list with a 2G base station neighbor that is higher ranked than the low-ranked 2G base station neighbor;
periodically repeating the ranking and replacing steps.

2. The method of claim 1, wherein the steps are performed at a central location across multiple RATs.

3. The method of claim 1, wherein the ranking parameters include geographically identified NBR records and whitelists/blacklists (WL/BL).

4. The method of claim 1, wherein the steps are performed at at non-real time (non-RT) radio intelligent controller (RIC).

5. The method of claim 1, further comprising replacing using a minimum impact threshold.
